(19) United States
(12) Patent Application Publication
(10) Pub. No.: US 2009/0023476 A1
(43) Pub. Date: Jan. 22, 2009

(54) APPARATUSES AND METHODS FOR FACILITATING COMMUNICATION OF DEVICES

(75) Inventors: Mikko Saarisalo, Kantvik (FI); Jussi Lahdenniemi, Julkujarvi (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/778,458

(22) Filed: Jul. 16, 2007

(51) Int. Cl. H04B 1/38

(52) U.S. Cl. 455/561

(57) ABSTRACT

A system for facilitating communication between an initiator and a target is provided. The initiator transmits a signal to the target including an indication of the communication capability of the initiator. For example, the indication may specify that the initiator is a peer-to-peer capable device. In this way, if the target is configured to communicate according to multiple techniques, such as peer-to-peer protocols and proximity card techniques, the target may be able to determine the appropriate communication method to use. Furthermore, the target may be able to change from a smart card emulation to a peer-to-peer configuration based on the indication received. Corresponding methods, apparatuses, and computer program products are also provided.

### TECHNOLOGICAL FIELD

Embodiments of the present invention relate generally to communications technology, devices, and, more particularly, to facilitating communication between devices.

### BACKGROUND

From credit cards to access-control cards to public transportation payment cards, the use of devices to communicate information in our society is continuing to grow and to affect more aspects of our daily life. Some such devices, which may include electronic identification cards and mobile terminals, act as “smart cards” that can receive an input, process the input, and deliver an output. For example, a growing number of people worldwide are using smart cards for payment and ticketing applications, such as mass transit.

Contact smart cards require contact with electrical connectors that can read information from the device (e.g., from a chip embedded in a plastic card) and write information back. For example, a contact smart card may be inserted into a reader, which acts as a communications medium between the smart card and another device, such as a computer. Contactless smart cards, on the other hand, are designed to communicate through Radio Frequency Identification (RFID) induction and require only proximity to a reader to communicate.

Some devices, such as mobile terminals, are capable of performing card emulation so as to function as smart cards to communicate with other devices using short-range wireless technology, such as Near Field Communication (NFC) and RFID technology. For example, a mobile terminal may be able to communicate with a point-of-sale (POS) device to complete a consumer transaction, for example according to a smart card standard such as ISO 14443, and may also be able to communicate with other mobile terminals in the area using a peer-to-peer communications protocol (such as according to ECMA 340 or ISO 18092 standards).

In some cases, a device (i.e., a target) that supports both card emulation and peer-to-peer functionality may experience inefficiencies when determining which protocol to use to communicate with another device (i.e., an initiator). As a result, the target may not be able to meet performance requirements imposed by the initiator. In addition, communicating according to one communications protocol may prevent the target from being responsive to other potential initiators seeking to communicate according to other communications protocols. Also, the target may not be able to provide instantaneous feedback to the user even though the target may be communicating with the initiator according to the appropriate communications protocol.

Thus, there is a need for a way to facilitate communication between targets and initiators such that the appropriate communications link is established with limited effects on the communication itself.

### BRIEF SUMMARY

An apparatus, method, computer program product, and system are therefore provided for facilitating communication between targets and initiators. An initiator may transmit a signal to a target including an indication of the communication capability of the initiator. In this way, the target may be able to determine the appropriate communication method to use for communicating with the initiator.

In one exemplary embodiment, an apparatus for facilitating communication is provided. The apparatus comprises a processor configured to receive signals from one of a number of potential devices including an indication of a communication capability of the device. The communication capability may include a communications protocol. The processor is also configured to provide for signals to be transmitted via the communications protocol based on the indication received.

The processor may provide for the signals to be transmitted to the device using a peer-to-peer communications protocol when the indication indicates that the device is peer-to-peer capable. In some embodiments, the processor may provide for the signals to be transmitted to the device according to a proximity card technique when the indication is absent.

The apparatus may further comprise a transmitter in communication with the processor configured to transmit signals and a receiver in communication with the processor configured to receive signals. The transmitter and the receiver may be configured to transmit and receive signals, respectively, according to ISO 14443-4 or Mifare, among other techniques. The receiver and the transmitter may be included in a Near Field Communications chip. Furthermore, the apparatus may include a secure element in communication with the processor, and the secure element in cooperation with the transmitter may provide for the signals to be transmitted to the device according to a proximity card technique when the indication is absent so as to emulate a smart card. The processor may be configured to bypass the secure element if the indication indicates that the device is peer-to-peer capable. In some embodiments, the apparatus may include a mobile terminal. The apparatus may further include means for changing configuration between a smart card emulation and a peer-to-peer configuration.

In other exemplary embodiments, an apparatus is provided comprising a processor configured to provide for transmission of signals including an indication of a communication capability, wherein the communication capability includes a communications protocol, wherein the processor is configured to receive a response from a device that has received the transmitted signals, and wherein the processor is configured to provide for the signals to be transmitted via a communications protocol based on the response received.

The processor may provide for transmission of the indication including an inquiry regarding an availability of a predefined software application on the device. The processor may provide for the signals to be transmitted using a peer-to-peer communications protocol if the response to the indication comprises a predefined response. Furthermore, the processor may provide for a repeat transmission of the indication if the response to a first transmission of the indication comprises a predefined response. The processor may provide for the signals to be transmitted according to a proximity card technique if the response to the indication comprises a predefined response.

The apparatus may also include a transmitter in communication with the processor, wherein the transmitter may be configured to transmit signals according to an ISO 14443-4 or Mifare technique, among others. The apparatus may also include means to select a smart card emulation or a peer-to-peer configuration.

In other exemplary embodiments, a method and computer program product for facilitating communication are provided. The method and computer program product receive a signal including an indication of a communication capability of a device, determine a communications protocol based on the indication, and communicate using the communications protocol determined.

A first response may be transmitted when the indication is received a first time. The configuration may be changed to communicate using the communications protocol determined, and a second response may be transmitted when the indication is received a second time. Furthermore, the signal may be received while emulating a smart card, and changing the configuration may include changing from a smart card emulation to a peer-to-peer communications protocol configuration. In addition, a signal from another device not including the indication may be received, and communication may occur with the other device according to a proximity card technique.

In another exemplary embodiment, an apparatus for facilitating communication is provided that includes means for receiving signals including an indication of a communication capability of a device, wherein the communication capability comprises a communications protocol. The apparatus may also include means for transmitting signals in response to the signals received and means for providing for the signals to be transmitted via the communications protocol based on the indication received.

In another exemplary embodiment, a system for facilitating communication is provided. The system includes a first device configured to transmit a signal including an indication of a communication capability and a second device configured to receive the signal and to communicate with the first device. The second device may be configured to provide a first response to the first device and to communicate with the first device using a communications protocol based on the indication if the second device has a communication capability that corresponds with the communication capability indicated by the first device.

The second device may be configured to provide a second response to the first device if the second device has a communication capability that does not correspond with the communication capability indicated by the first device, and the first device may be configured to communicate with the second device according to a proximity card technique based on the second response. The first device may be configured to communicate with the second device using a peer-to-peer communications protocol based on the second response. Furthermore, the first device may comprise a point-of-sale device.

The system may also include a clearance element configured to receive data from the first device over a wide are data network regarding payment by the second device. The clearance element may be configured to communicate with the second device to update account information based on the data received from the first device.

Furthermore, the first device may be configured to repeat transmission of the signal including the indication to the second device if the response from the second device to a first transmittal of the indication comprises a second response. The first and/or the second device may be a mobile terminal.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 is a schematic representation of a system including an initiator and a target, such as a credit card;

FIG. 4 is a schematic representation of a system according to an exemplary embodiment of the present invention;

FIG. 5 is a schematic block diagram of an initiator according to an exemplary embodiment of the present invention;

FIG. 6 is a schematic block diagram of a target according to an exemplary embodiment of the present invention;

FIG. 7 is a schematic block diagram of a target according to another exemplary embodiment of the present invention;

FIG. 8A is a schematic block diagram of a communication between an initiator according to an exemplary embodiment of the present invention and a target;

FIG. 8B is an illustration of a communication between the initiator and target of FIG. 8A according to an exemplary embodiment of the present invention;

FIG. 9A is a schematic block diagram of a communication between an initiator according to an exemplary embodiment of the present invention and a target emulating a smart card according to an exemplary embodiment of the present invention;

FIG. 9B is a schematic block diagram of a communication between an initiator according to an exemplary embodiment of the present invention and a target according to an exemplary embodiment of the present invention when the secure element has been bypassed;

FIG. 9C is an illustration of a communication between the initiator and target of FIGS. 9A and 9B according to another exemplary embodiment of the present invention;

FIG. 10A is a schematic block diagram of a communication between an initiator and a target according to an exemplary embodiment of the present invention;

FIG. 10B is an illustration of a communication between the initiator and target of FIG. 10A according to another exemplary embodiment of the present invention;

FIG. 11 is a schematic representation of a system including a clearance element according to another exemplary embodiment of the present invention;

FIG. 12 illustrates a flowchart according to an exemplary embodiment for facilitating communication; and

FIG. 13 illustrates a flowchart according to another exemplary embodiment for facilitating communication.

### DETAILED DESCRIPTION

Embodiments of the present inventions now will be described more fully hereinafter with reference to the accompanying drawings, in which some, but not all embodiments of the inventions are shown. Indeed, embodiments of these inventions may be embodied in many different forms and should not be construed as limited to the embodiments set forth herein; rather, these embodiments are provided so that this disclosure will satisfy applicable legal requirements. Like reference numerals refer to like elements throughout.

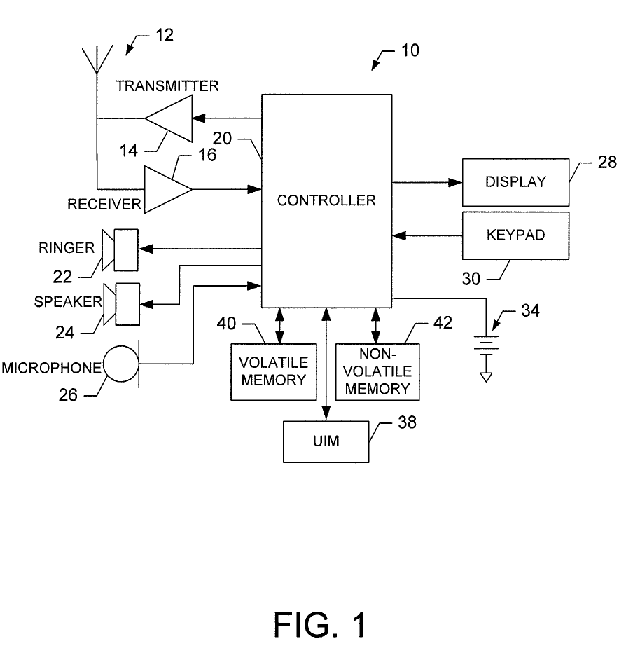

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as portable digital assistants (PDAs), pagers, mobile televisions, MP3 or other music players, cameras, laptop computers and other types of voice and text communications systems, can readily employ the present invention.

In addition, while several embodiments of the present invention will benefit a mobile terminal 10 as described below, embodiments of the present invention may also benefit and be practiced by other types of devices, i.e., fixed terminals. Moreover, the system and method of embodiments of the present invention will be primarily described in conjunction with mobile communications applications. It should be understood, however, that the system and method of the present invention can be utilized in conjunction with a variety of other applications, both in the mobile communications industries and outside of the mobile communications industries. Accordingly, embodiments of the present invention should not be construed as being limited to applications in the mobile communications industry.

In one embodiment, however, at least one of the communicating devices (i.e., the initiator, the target, or both) is a mobile terminal 10. Although the mobile terminal may be embodied in different manners, the mobile terminal 10 of one embodiment includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 of this embodiment also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 includes the conventional numeric (0-9) and related keys (#, *), and other keys used for operating the mobile terminal 10. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

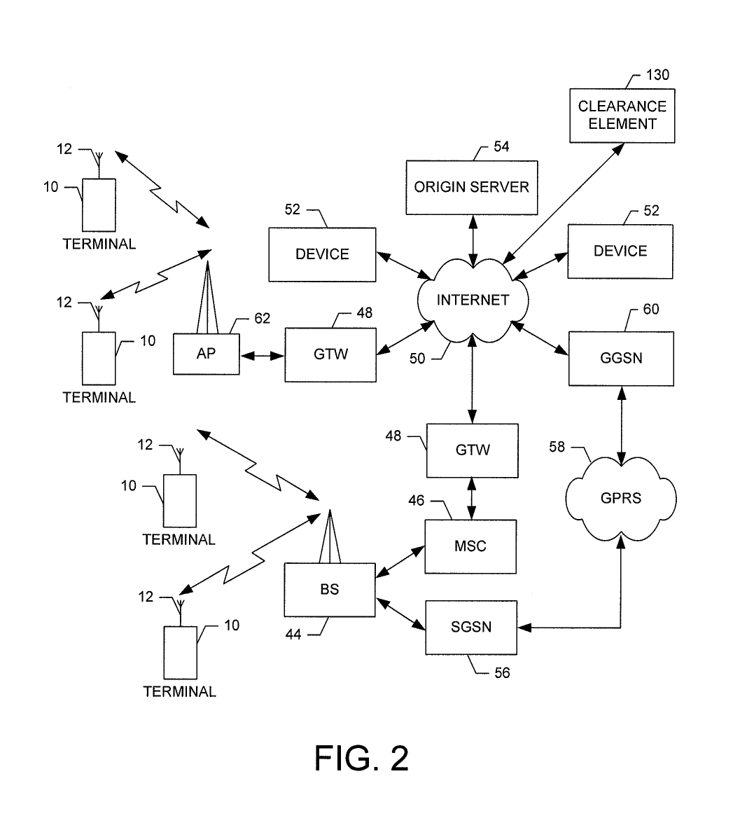

Referring now to FIG. 2, an illustration of one type of system that would benefit from and otherwise support embodiments of the present invention is provided. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a device 52 (two shown in FIG. 2), origin server 54 (one shown in FIG. 2), clearance element 130 (one shown in FIG. 2), or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a device 52, origin server 54, and/or clearance element 130 may be coupled to the mobile terminal 10 via the Internet 50, SGSN 56 and GGSN 60. In this regard, devices such as the device 52, origin server 54, and/or clearance element 130 may communicate with the mobile terminal 10 across the SGSN 56, GPRS core network 58 and the GGSN 60. By directly or indirectly connecting mobile terminals 10 and the other devices (e.g., device 52, origin server 54, clearance element 130, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the device 52, the origin server 54, the clearance element 130, and/or any of a number of other devices, to the Internet 50, the mobile terminals 10 can communicate with one another, the device, etc., to thereby carry out various functions of the mobile terminals 10, such as to transmit data, content or the like to, and/or receive content, data or the like from, the device 52. As used herein, the terms “data,” “content,” “information,” “signals” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to devices 52 across the Internet 50, the mobile terminal 10 and device 52 may be coupled to one another and communicate in accordance with, for example, RF, BT, IrDA or any of a number of different wireline or wireless communication techniques, including LAN, WLAN, WiMAX and/or UWB techniques. One or more of the devices 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the devices 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

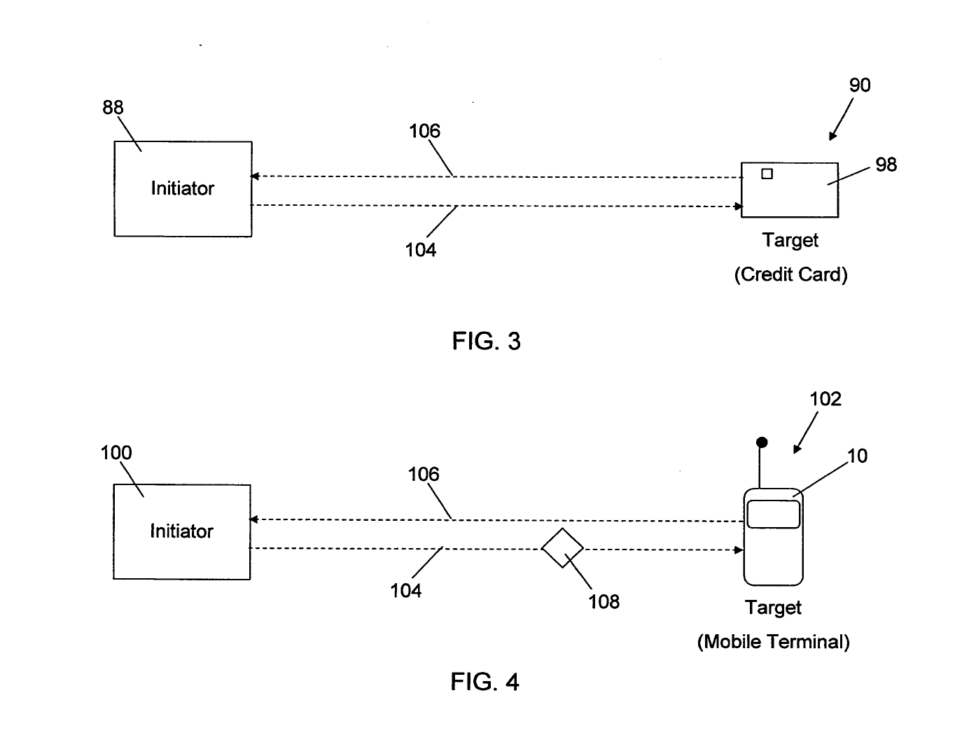

FIG. 3 illustrates a typical system for communicating data between an initiator 88 and a target 90. As an example, the initiator 88 of FIG. 3 may be a point-of-sale (POS) device, and the target 90 may be a credit card 98 with smart card functionality. In this example, the credit card 98 may be a contactless smart card such that proximity of the credit card 98 to the initiator 88 (for example, when the credit card 98 is within 7 cm of the initiator 88) allows the credit card 98 to receive a signal 104 from the initiator 88.

The signal 104 transmitted by the initiator 88 in this case, in which the credit card is a passive target, may include a power component and a communication component. The credit card 98 may be configured to capture at least part of the power component such that the credit card 98 may be energized and able to communicate with the initiator 88. The communication component of the signal 104 may request that the credit card 98 invoke a certain application, such as a payment application, so that the initiator 88 and the credit card 98 may engage in a payment transaction, for example.

The credit card 98 may in turn respond to the request in the communication component of the signal 104 from the initiator 88 by transmitting a response signal 106, which may indicate that the credit card 98 is present and is able to engage in the transaction with the initiator 88. The response signal 106 from the credit card 98 may include information about the credit card 98, such as the communication capability of the credit card 98 (i.e., how the initiator 88 should communicate with the credit card 98 in order to complete the transaction). The credit card 98, for example, may be configured to communicate according to proximity card techniques including those employing smart card techniques, such as those defined by ISO 14443-2, 14443-3, 14443-4, FELICA®, Mifare A, or Mifare B standards, among others. In this regard, proximity cards may include any contactless integrated circuit devices, and the communication techniques used may include NFC, RFID, or other short range wireless protocols. The credit card 98 may also specify the modulation schemes, coding, transfer speeds, and frame format of its interface, as well as other information.

Thus, in the typical situation described in FIG. 3, it is the target 90 (in this case the credit card 98) that provides information regarding the specifications and protocols necessary for communicating. Such information provided by the target 90 may allow effective communication when the target 90 is only configured to communicate according to one type of communications protocol; however, if the target 90 is configured to communicate according to multiple communications protocols, the target 90 may not be able to determine which communication capability to specify (i.e., which communication capability would correspond to the communication capability of the initiator 88) or may spend too much time making the determination, resulting in a failure or at least a delay of the communication.

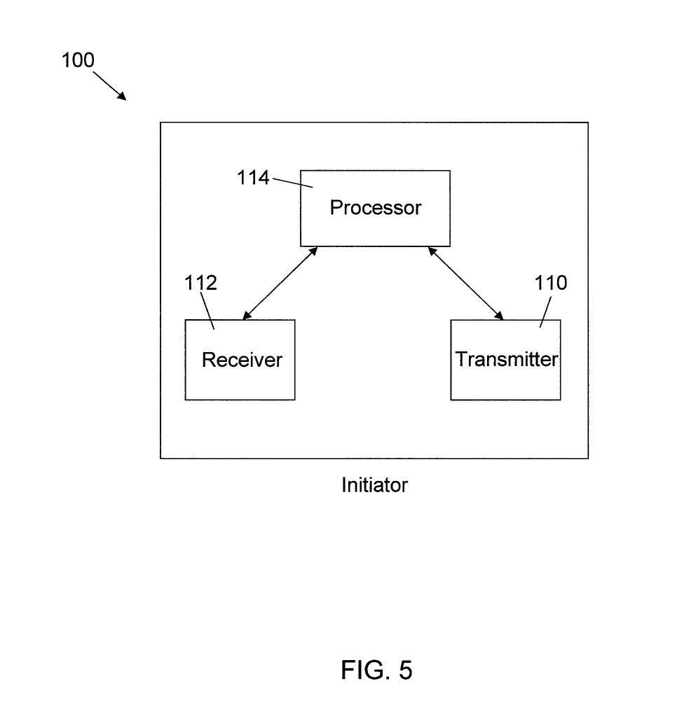

An exemplary embodiment of the invention will now be described with reference to FIG. 4, in which certain elements of a system for facilitating communication between devices is displayed. The system of FIG. 4 may be employed, for example, with the mobile terminal 10 of FIG. 1 or other devices 52 depicted generally in FIG. 2. However, it should be noted that the system of FIG. 4, may also be employed with a variety of other devices, both mobile and fixed, and therefore, embodiments of the present invention should not be limited to use with devices such as the mobile terminal 10 of FIG. 1 or the devices 52 communicating via the network of FIG. 2.

In an exemplary embodiment, such as the one shown in FIG. 4, data may be communicated over the network of FIG. 2 between an initiator 100 and a target 102. The initiator 100 may be, for example, a POS device or reader that is configured to act as a communication medium between the target 102 and a host (such as a computer, not shown), or the initiator 100 may be the mobile terminal 10 of FIGS. 1 and 2 or any other device 52 of the system of FIG. 2. Similarly, the target 102 may be the mobile terminal 10 of FIGS. 1 and 2 or any other device 52 of the system of FIG. 2. However, it should be understood that the network of FIG. 2 need not be employed for communication between the initiator 100 and the target 102, but rather FIG. 2 is merely provided for purposes of example. Furthermore, it should be understood that embodiments of the present invention may be embodied in software as described below that may be resident on the initiator 100 and/or the target 102, such as the mobile terminal 10, the device 52, or any other network device accessible by either the initiator 100 or the target 102.

The initiator 100, the target 102, or both the initiator 100 and the target 102 may be configured to function according to embodiments of the present invention. For example, FIG. 4 illustrates a situation in which at least the initiator 100 is configured to function according to embodiments of the present invention. As such, the initiator 100 of FIG. 4 is configured to transmit a signal 104 that includes an indication 108 of the communication capability of the initiator 100 to the target 102 (which, in FIG. 4, is shown as a mobile terminal 10). As previously mentioned, the signal 104 may include a power component and a communication component. In this case, at least a portion of the communication component may also include the indication 108. The indication 108 may provide information to the target 102 regarding the way the initiator 100 prefers to communicate. For example, the indication 108 may specify a communications protocol, such as peer-to-peer, so that if the target 102 is configured to communicate according to multiple protocols, the target 102 may be able to determine the appropriate protocol to use.

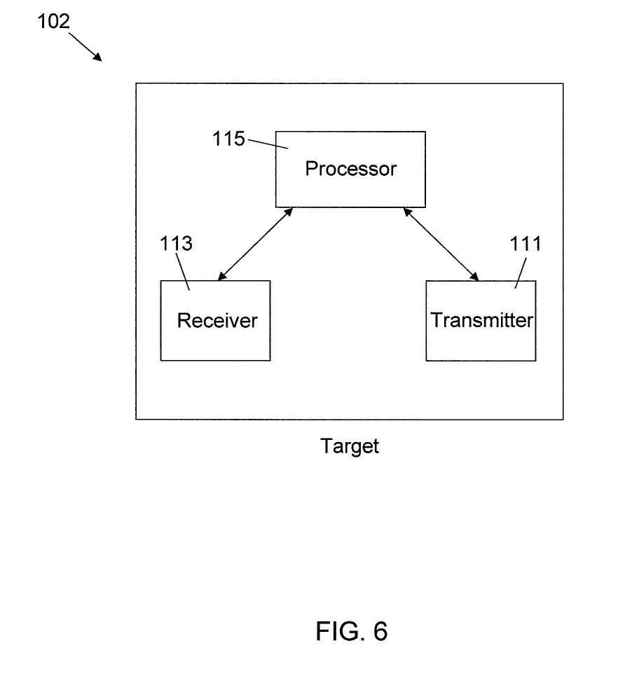

The initiator 100 may include a transmitter 110, a receiver 112, and a processor 114, as shown in FIG. 5. The transmitter 110 may be configured to transmit signals 104 including the indication 108 of the communication capability of the initiator 100, which may specify the communications protocol preferred for the communication. The receiver 112 may be configured to receive a response 106 from the target 102, which has received the transmitted signals 104. The processor 114 may be in communication with both the transmitter and the receiver such that the processor 114, in cooperation with the transmitter 110, may provide for the signals 104 to be transmitted via a communications protocol based on the response 106 received, as will be described below.

For example, referring again to FIG. 4, the initiator 100 may transmit an indication 108 to the target 102 that includes an inquiry regarding the availability of a predefined software application on the target 102. The software application, for example, may be called “initiator_parameters.AID,” and reference to this particular application may indicate to the target 102 that the initiator 100 prefers to communicate according to a certain technique, such as peer-to-peer. It should be understood, however, that the software application may have any name and is not limited to the extension “AID.” Continuing this example, “initiator_parameters.AID” may include executable instructions regarding communication according to a communications standard, such as ISO/IEC 7816. If the target 102 recognizes the referenced application (in this case “initiator_parameters.AID”), the initiator 100 may receive a response 106 from the target 102 indicating that the target 102 is configured to communicate according to the protocol and specifications included in the application. The initiator 100 and the target 102 may then proceed to communicate according to their mutual communication capabilities. In other words, although there is no need for the target 102 to have a specific application (e.g., “initiator_parameters.AID”) installed, the application identification mechanism may be used to communicate the initiator capabilities in a manner that does not cause problems with existing implementations and infrastructures, rather than to identify a particular application.

However, if the target 102 does not recognize the referenced application, for example because the target 102 is configured to function like the target 90 of FIG. 3 and is not configured to communicate according to the capabilities of the initiator 100, the initiator 100 may receive a response 106 from the target 102 indicating that the target 102 does not recognize or cannot find the referenced file. In this case, the initiator 100 may wait a certain amount of time (e.g., 5 ms) and then attempt to transmit the indication 108 to the target 102 a second time. If the initiator 100 again receives a response 106 indicating that the target 102 does not recognize the referenced file, the initiator 100 may query the target 102 regarding the communications capability of the target 102, as previously described and shown in FIG. 3. As a result, the initiator 100 may determine the appropriate communications protocol for engaging the target 102, which may be a communications protocol other than that indicated. For example, the initiator 100 may determine that a communications protocol according to a smart card standard is appropriate for communicating with the target 102 based on the target's response 106. The initiator 100 may use various protocols and standards for communicating with the target 102 based on the target's response, such as ISO 14443-4 and Mifare.

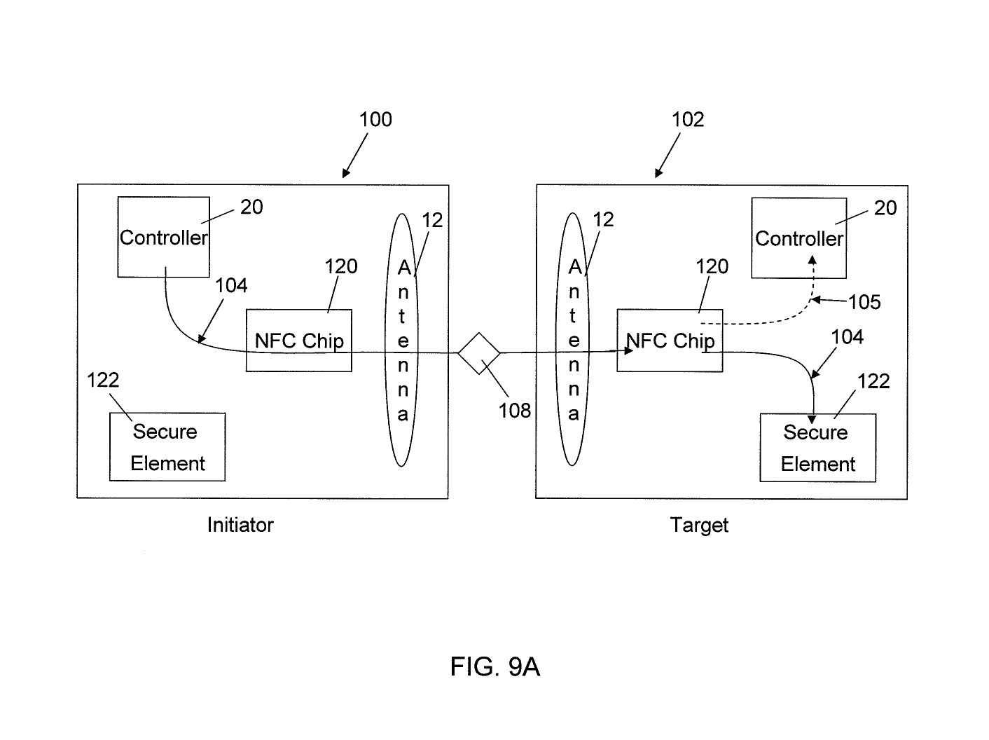

An example of a communication between the initiator 100 and a target that does not recognize the predefined software application referenced in the indication 108 (i.e., the target 90 of FIG. 3) is shown in FIG. 8 A, and the signals 104 and the responses 106 of the initiator 100 and the target 90, respectively, are shown in FIG. 8B. Thus, in FIGS. 8A and 8B, the initiator 100 may transmit the indication 108 (SELECT “initiator_parameters.AID”) twice to the target 90, waiting 5 ms between transmissions. However, as the target 90 does not recognize the application in this example, the initiator 100 may receive the response 106 “file not found” twice. The initiator 100 may be configured to repeat the transmission of the indication 108 more than twice. Once the initiator 100 is satisfied that the target 90 does not recognize the application, the initiator 100 may transmit a query to the target 90 requesting that the target 90 access the normal application required for the transaction, such as the payment application (SELECT “application”). In its response, not shown, the target 102 may proceed by providing details regarding the target's communication capability, as previously described in connection with FIG. 3.

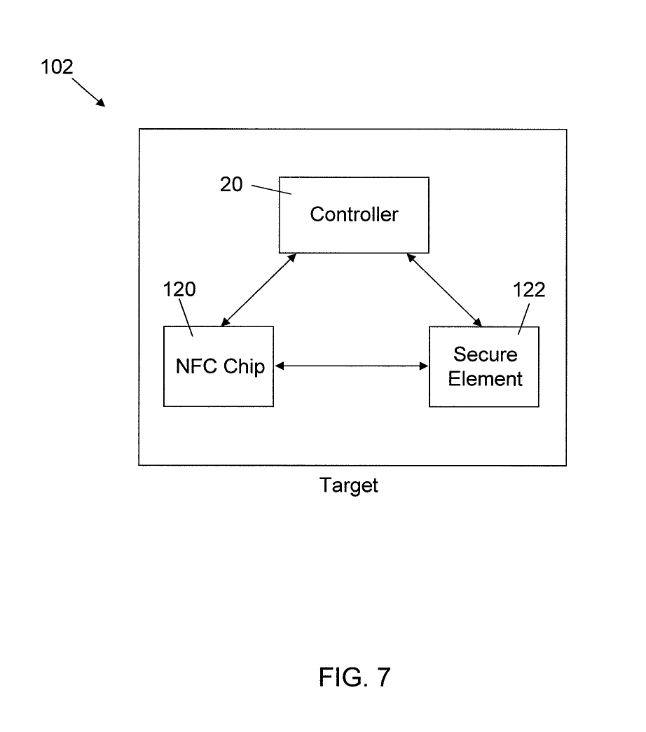

In some cases, both the initiator 100 and the target 102 may be configured to function according to embodiments of the present invention. Referring to FIGS. 4 and 6, the target 102 may include a receiver 113, a transmitter 111, and a processor 115. The receiver 113 or other means for receiving signals may be configured to receive signals from one of a number of potential devices, such as the initiator 100, and the signals 104 may include an indication 108 of a communication capability of the initiator 100. The communication capability may include, for example a communications protocol via which the initiator 100 prefers to communicate. For instance, the target 102 may receive an indication 108 from the initiator 100 indicating a preference of the initiator 100 to communicate according to a peer-to-peer protocol. The indication 108 may also include other specifications regarding communication, such as coding, transfer speeds, and other information.

The transmitter 111 of the target 102 (or other means of transmitting signals) may be configured to transmit signals 106 in response to the signals 104 received from the initiator 100. The processor 115 of the target 102 may communicate with the receiver 113 and the transmitter 111 such that the processor 115, e.g., in cooperation with the transmitter, may provide for the signals 106 to be transmitted to the initiator 100 via the communications protocol based on the indication 108 received from the initiator 100. The processor 115 may include, for example, the controller 20 of the mobile terminal 10 of FIG. 1 or any other means for providing for the signals 106 to be transmitted via the communications protocol based on the indication 108 received.

As previously discussed, the target 102 may be configured to communicate (i.e., transmit and receive signals) according to multiple communications techniques, such as peer-to-peer protocols and/or proximity card techniques (e.g., techniques defined by standards such as ISO 14443-4 and Mifare, among others). For example, the target 102 may be the mobile terminal 10 of FIG. 1 and may be configured to engage in peer-to-peer communications with other mobile terminals 10 and initiators 100 as well as to engage in other transactions in which the mobile terminal 10 may act as a smart card target. In this regard, the target 102 in FIG. 4 (which is a mobile terminal 10 in this example) may determine how to communicate with the initiator 100 based on the indication received from the initiator 100. Thus, if the target 102 receives an indication 108 from the initiator 100 indicating that the initiator is peer-to-peer capable, for example, the target 102 may communicate with the initiator 100 using a peer-to-peer communications protocol. In some cases, the target 102 may receive signals 104 that do not include an indication 108 of communication capability, similar to the signals 104 shown in FIG. 3. In these cases, the target 102 may communicate with the initiator 100 using a different technique (for example according to standards such as ISO 14443-4 or Mifare) or any other technique preferred by the target 102, as previously described in connection with FIG. 3. It should be noted that the target 102 may also be configured to perform various other tasks, such as RF modulation, bit encoding, and anti-collision functions before, during, or after receiving signals 104 from the initiator 100.

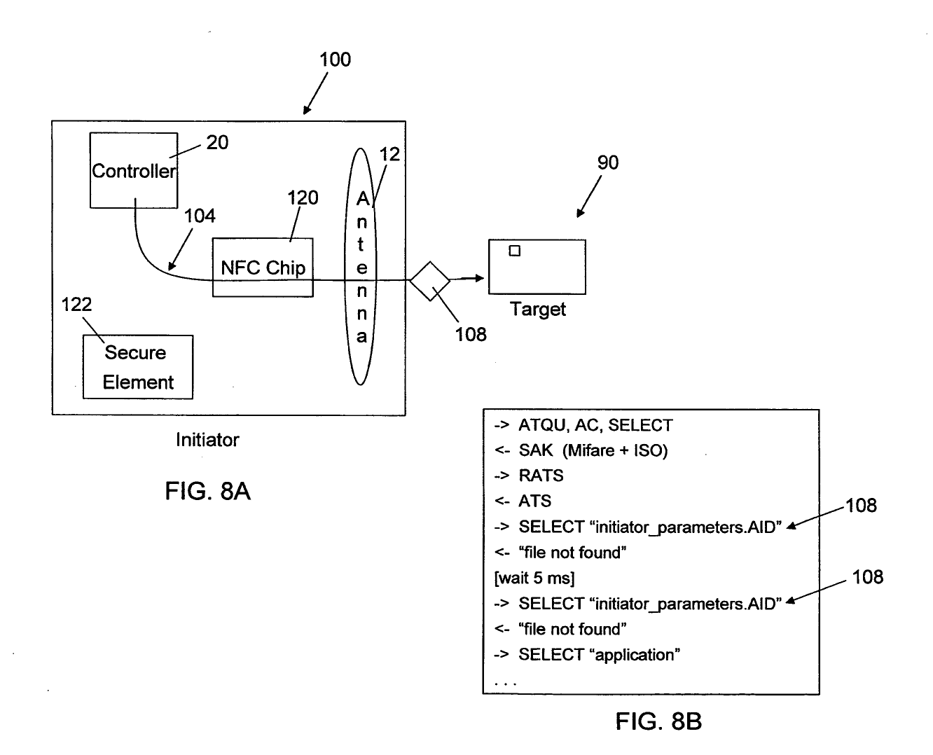

In an exemplary embodiment illustrated in FIG. 7, the target 102 may be a mobile terminal 10, such as a mobile phone, that includes a processor, such as a controller 20, and an NFC chip 120 in communication with the processor. The NFC chip 120 may be, at a minimum an NFC modem that translates logical (i.e., binary) data to analog signals. In the embodiment of FIG. 7, the NFC chip 120 may include a transmitting element and a receiving element such that a separate transmitter 111 and receiver 113, shown in FIG. 6, are not necessary. The NFC chip 120 may also perform additional functions, for example encrypting sensitive information such as credit card information and performing various logical tasks such as executing a polling loop or handling anti-collision and protocol selection tasks.

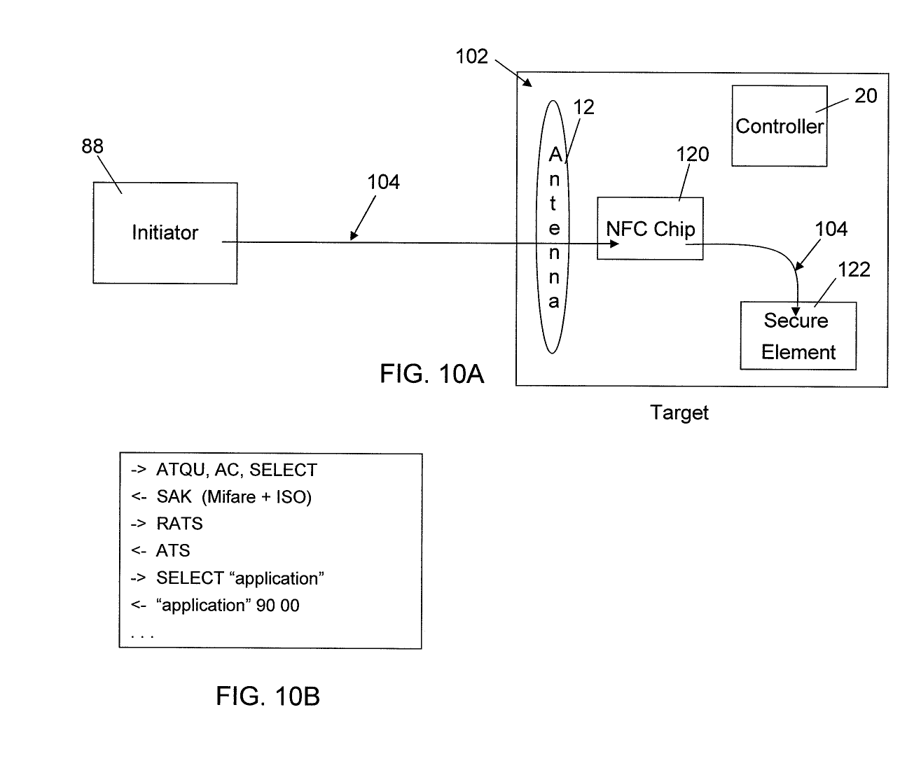

The target 102 may also include a secure element 122 or other tamper resistant component in communication with the processor (e.g., the controller 20), as shown in FIG. 7. The secure element 122 may be a hardware component that provides tamper resistance or it may be software-based. The secure element 122 may be for example an SIM or other type of UIM 38, as shown in FIG. 1 and previously described, or it may be a miniature piece of silicon. In some cases, the secure element may be embedded in a removable memory card, such as a Secure Digital (SD) memory card. The secure element 122, in cooperation with the NFC chip 120 or other transmitter 111 may provide for signals to be transmitted to the initiator 100 according to a proximity card technique when no indication 108 is received by the target 102. In other words, when an initiator that is not configured to transmit an indication 108 to the target 102, such as the initiator 88 of FIG. 3, attempts to communicate with the target 102 of FIG. 7, the NFC chip 120 may route such communications to the secure element 122 (as shown in FIG. 10A). In this way, the target 102 may emulate (i.e., function like) a smart card in transactions with the initiator 88.

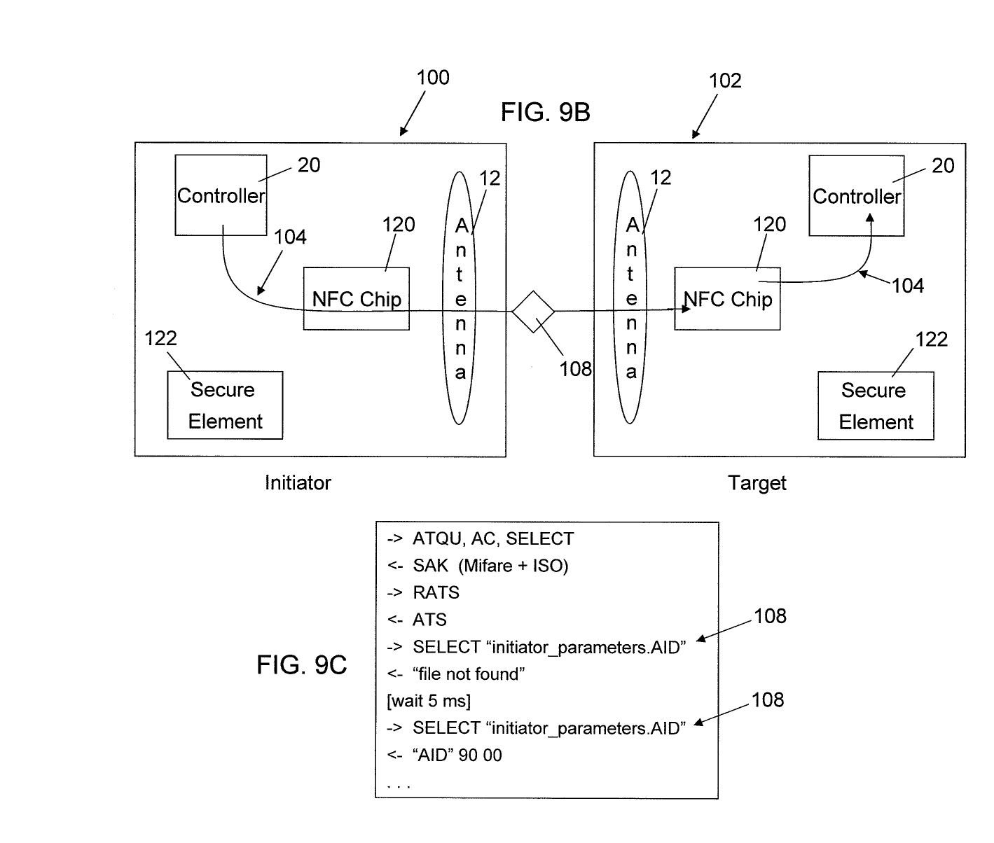

If an initiator 100 configured to function according to embodiments of the present invention attempts to engage a target 102 configured to function according to embodiments of the present invention (for example if both the initiator 100 and the target 102 of FIG. 4 are so configured), the target 102 may change its configuration to support communication according to the indication 108 received. For example, referring to FIG. 9A, the initiator 100 may transmit a signal 104 to the target 102 that includes an indication 108 of a communication capability of the initiator 100. As previously described, the indication 108 may be in the form of an inquiry regarding the availability of a predefined software application on the target 102, such as “initiator_parameters.AID.” The target 102 in this case may be configured to emulate a smart card when the target is in a passive, receiving mode (i.e., before a transaction has been initiated). As a result, the NFC chip 120 may route any signals 104 received at the target 102, including any indications 108, to the secure element 122. The secure element 122, which provides for the target 102 to emulate a smart card, may thus not recognize the referenced software application “initiator_parameters.AID” and may respond accordingly. However, through communication with the NFC chip 120, as depicted by the dotted line 105, the controller 20 may be aware that the indication 108 is being routed to the secure element 122. As a result, the controller 20 of the target 102 may be configured to bypass the secure element 122 when an indication 108 is received indicating a communications protocol that is unsupportable by the secure element 122. For example, if “initiator_parameters.AID” indicates that the initiator 100 is peer-to-peer capable, the controller 20 may bypass the secure element 122 such that the controller 20, in cooperation with the NFC chip 120, may provide signals according to a peer-to-peer communications protocol as specified by the indication 108, as shown in FIG. 9B.

An example of the signals 104, 106 that may be communicated between the initiator 100 and the target 102 in the previous example may be seen in FIG. 9C. For example, the initiator 100 may transmit the indication 108 (SELECT “initiator_parameters.AID”) a first time to the target 102 and may initially receive a response from the target 102 that the referenced application is not found (“file not found”). This may occur, for example, if the target 102 is a mobile terminal 10 configured as described in FIG. 9A and is emulating a smart card at the time the indication 108 is received. As a result, the secure element 122 in cooperation with the NFC chip 120 may not recognize the referenced application. The initiator 100 may wait a certain amount of time, such as 5 ms, and then repeat transmission of the indication 108 (SELECT “initiator_parameters.AID”). In the time between transmissions, the controller 20, which may have recognized the inquiry that was initially routed to the secure element 122, may reconfigure the target such that the secure element 122 is bypassed when the indication 108 is received a second time (as shown in FIG. 9B). As a result, the response to the second transmission, provided by the controller 20 in cooperation with the NFC chip 120, may indicate that the application is recognized and that the target 102 is able to communicate according to the specifications found in the application (“AID” 90 00). The response from the target 102 may also include additional capabilities of the target 102, desired configurations for communication, or other information about the target 102.

In some cases, a target 102 that is configured to function according to embodiments of the present invention may be engaged by an initiator 88 that is not configured to provide an indication 108 (e.g., the initiator 88 of FIG. 3). Although the target 102 in this case may be configured to receive an indication 108 from the initiator, the absence of such indication 108 may not preclude communication between the two devices. Rather, the target 102 may be configured to emulate the smart card 98 of FIG. 3 or otherwise communicate with the initiator 88 based on mutual communication capabilities. For example, as described above and illustrated in FIGS. 10A and 10B, the initiator 88 may transmit signals to the target 102 invoking a certain application, such as a payment application required to complete a commercial transaction (SELECT “application”). The target 102, having not received an indication of communication capability from the initiator 88, may respond by invoking the application (“application” 90 00) and proceed to transmit information to the initiator 88 regarding the communication capabilities (e.g., coding, transmission speeds, etc.) of the target 102. In this way, the transaction would take place as described above in connection with FIG. 3.

Some types of transactions may involve communications with other devices or network elements, such as the devices 52, servers, and systems of FIG. 2. For example, a commercial transaction between an initiator 100 and a target 102 may include communications with a clearance element 130, such as the clearance element 130 shown in FIG. 2. The clearance element 130 may be configured to receive data from the initiator 100 over a communications network, such as a wide area data network, regarding payment by the target 102. In this regard, the clearance element 130 may be a computer, a server, or any other type of system managed by a third party (such as a card association or credit card clearinghouse) responsible for crediting the account of one party to the transaction and debiting the account of the other party.

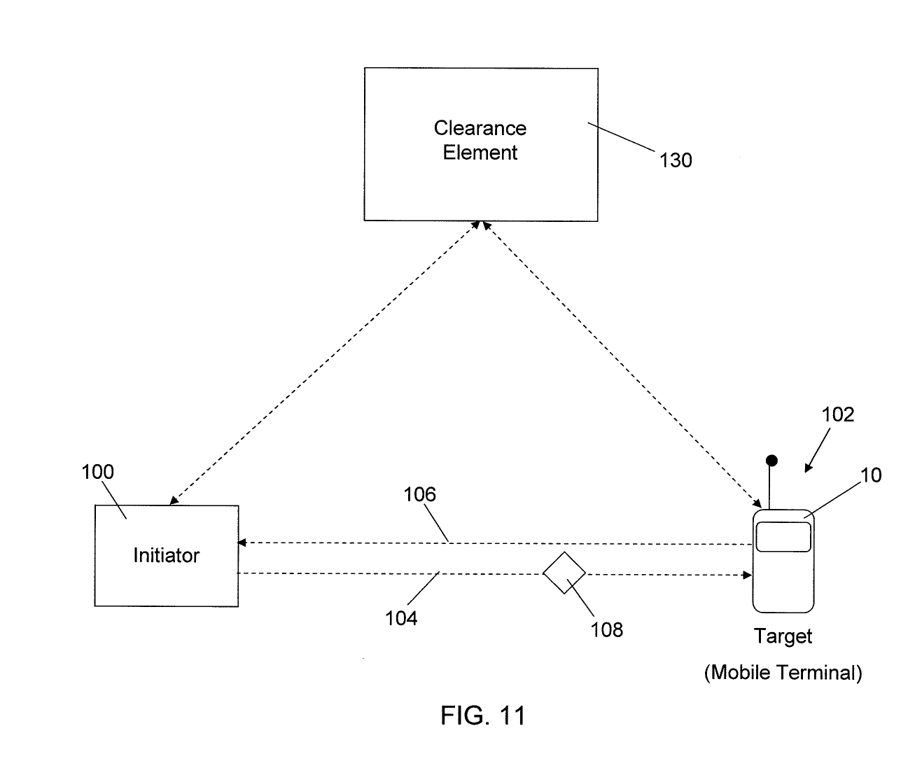

For example, referring to FIG. 11, in a commercial transaction involving a merchant associated with the initiator 100 and a consumer associated with the target 102, the target 102 may be used to provide the consumer's account information to the initiator 100 in order to pay for a good or service and complete the transaction. Thus, once the communication between the initiator 100 and the target 102 has been established according to embodiments of the present invention, the initiator 100 may receive the consumer's account information from the target 102. The initiator 100 may then communicate data, including the consumer's account information, the merchant's account information, the transaction amount, etc., to the clearance element 130 so that the clearance element 130 may credit the merchant's account in the amount of the transaction and debit the consumer's account accordingly. The clearance element 130 may be further configured to communicate with the target 102 to update the consumer's account information based on the data received from the initiator 100. In this way, the consumer's account information may reflect any credits or debits that resulted from the commercial transaction.

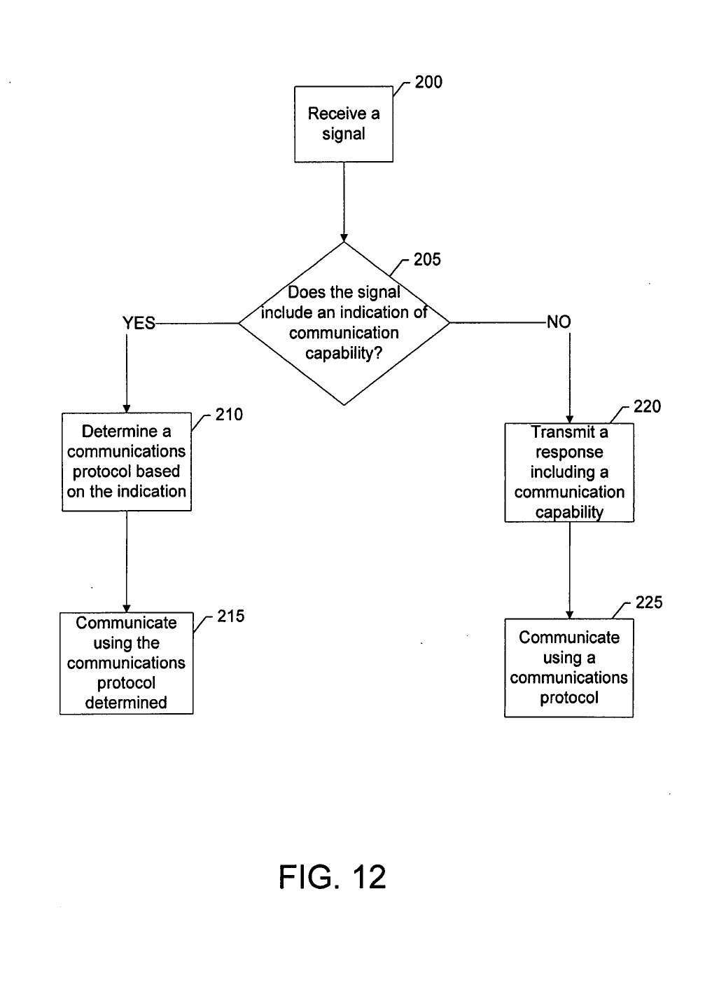

In other embodiments, a method for facilitating communication between devices is provided. Referring to FIG. 12, a signal is initially received. See FIG. 12, block 200. For example, the signal may be received at a target, such as a mobile terminal, and may have been transmitted by a number of devices acting as initiators, such as POS devices and other mobile terminals. As described above, various other tasks, such as RF modulation, bit encoding, and anti-collision functions may be performed before, during, or after receipt of the signal.

If the signal includes an indication of the communication capability of the transmitting device (i.e., the initiator), as previously described and illustrated in FIG. 4, a communications protocol may then be determined based on the indication. Blocks 205 and 210. For example, it may be determined that the initiator is a peer-to-peer capable device with a preference for communicating according to a peer-to-peer protocol. Furthermore, other standards and performance criteria may be determined regarding the method of communication based on the indication, such as modulation schemes, coding, transfer speeds, frame format, etc. In this way, communication may take place with the initiator via the communications protocol determined. Block 215.

However, the signal received may not include an indication of the communication capability of the initiator (for example, if the initiator is the initiator 88 of FIG. 3). In this case, a response to the signal may be transmitted including a communication capability of the device transmitting the response. See block 220. In other words, a target receiving a signal from an initiator that does not include an indication of the initiator's communication capability may respond by communicating the capability of the target itself, as described above. As a result, the initiator receiving this response may know how to communicate with the target, and communication may take place according to a communications protocol determined by the initiator, typically from among those communication capabilities identified and supported by the target. See block 225. The target may, for example, provide information that results in communication using a proximity card technique according to a smart card standard.

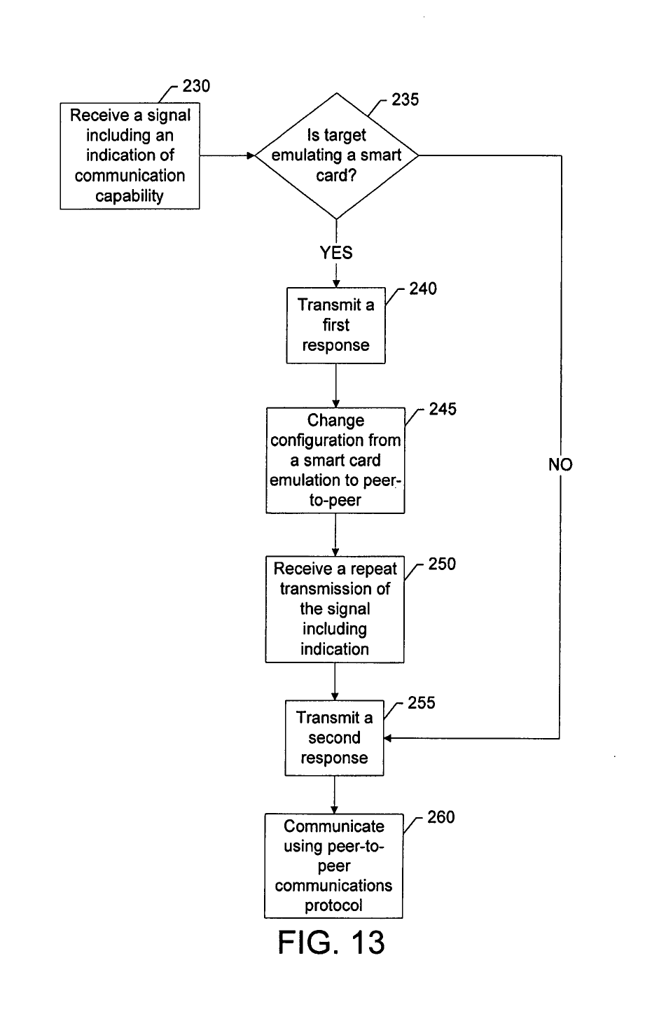

In other embodiments, a signal may be received that includes an indication of the communication capability of the initiator. FIG. 13, block 230. For example, the initiator may transmit a signal to a target inquiring whether the target has a particular software application installed. Reference to the application, such as “initiator_parameters.AID” previously discussed, may indicate that the initiator is a peer-to-peer capable device. If the target is not emulating a smart card and is otherwise capable and ready to communicate according to the indication, a response may be transmitted to the initiator so stating. See block 255. Such a response may also include additional capabilities of the target, desired configurations for communication, or other information about the target. Communication using the peer-to-peer communications protocol provided in the indication (e.g., specified by the referenced application) may then take place. Block 260.

Although the target may indeed recognize the referenced application and may be able to communicate according to the technique indicated, the target may be emulating a smart card at the time the signal including the indication is received, as previously described. See block 235. In this case, a first response indicating that the referenced file is not found, or otherwise (falsely) stating that the target is not able to communicate according to the indication, may be transmitted to the initiator. Block 240.

The smart card emulation may, however, be changed to support peer-to-peer communications. Block 245. For example, the processor of the target may bypass a secure element that was providing the smart card emulation so that the target may be able to respond as a peer-to-peer capable device. As a result, upon receiving a repeat transmission of the signal from the initiator including the indication (for example 5 ms after the first transmission), a second response may be transmitted stating that the target is able to communicate according to the indication. Blocks 250 and 255. Thus, if the indication was in the form of an inquiry regarding the availability of a software application such as “initiator_parameters.AID,” the second response may state that the referenced application is recognized and that the target is ready to communicate. As a result, communication according to the peer-to-peer communications protocol specified in the indication and/or executable instructions in the referenced application may take place. Block 260.

Exemplary embodiments of the present invention have been described above with reference to block diagrams and flowchart illustrations of methods, apparatuses, and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus, such as the controller 20 (shown in FIGS. 1 and 7), the processor 114 (shown in FIG. 5), and/or the processor 115 (shown in FIG. 6), to function in a particular manner, such that the instructions stored in the computer-readable memory produce an article of manufacture including computer-readable instructions for implementing the function specified in the flowchart block or blocks illustrated in FIGS. 12 and 13. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus comprising:
a processor configured to receive signals provided by one of a plurality of potential devices including an indication of a communication capability of the device, wherein the communication capability comprises a communications protocol, the processor also configured to provide for signals to be transmitted via the communications protocol based on the indication received.

2. The apparatus of claim 1, wherein the processor provides for the signals to be transmitted to the device using a peer-to-peer communications protocol when the indication indicates that the device is peer-to-peer capable.

3. The apparatus of claim 1, wherein the processor provides for the signals to be transmitted to the device according to a proximity card technique when the indication is absent.

4. The apparatus of claim I further comprising a transmitter in communication with the processor configured to transmit signals and a receiver in communication with the processor configured to receive signals.

5. The apparatus of claim 4, wherein the transmitter and the receiver are configured to transmit and receive signals, respectively, according to a technique selected from the group consisting of ISO 14443-4 and Mifare.

6. The apparatus of claim 4, wherein the receiver and the transmitter are included in a Near Field Communications chip.

7. The apparatus of claim 4 further comprising a secure element in communication with the processor, wherein the secure element in cooperation with the transmitter provides for the signals to be transmitted to the device according to a proximity card technique when the indication is absent so as to emulate a smart card.

8. The apparatus of claim 7, wherein the processor is configured to bypass the secure element if the indication indicates that the device is peer-to-peer capable.

9. The apparatus of claim 1, wherein the apparatus comprises a mobile terminal.

10. The apparatus of claim 1 further comprising means for changing configuration between a smart card emulation and a peer-to-peer configuration.

11. An apparatus comprising:
a processor configured to provide for transmission of signals including an indication of a communication capability, wherein the communication capability comprises a communications protocol, wherein the processor is configured to receive a response from a device that has received the transmitted signals, and wherein the processor is configured to provide for the signals to be transmitted via a communications protocol based on the response received.

12. The apparatus of claim 11, wherein the processor provides for transmission of the indication comprising an inquiry regarding an availability of a predefined software application on the device.

13. The apparatus of claim 11, wherein the processor provides for the signals to be transmitted using a peer-to-peer communications protocol if the response to the indication comprises a predefined response.

14. The apparatus of claim 11, wherein the processor provides for a repeat transmission of the indication if the response to a first transmission of the indication comprises a predefined response.

15. The apparatus of claim 11, wherein the processor provides for the signals to be transmitted according to a proximity card technique if the response to the indication comprises a predefined response.

16. The apparatus of claim 15 further comprising a transmitter in communication with the processor, wherein the transmitter is configured to transmit signals according to a technique selected from the group consisting of ISO 14443-4 and Mifare.

17. The apparatus of claim 11 further comprising means to choose a configuration selected from the group consisting of a smart card emulation and a peer-to-peer configuration.

18. A method comprising:
receiving a signal including an indication of a communication capability of a device;
determining a communications protocol based on the indication; and
communicating using the communications protocol determined.

19. The method of claim 18 further comprising:
transmitting a first response when the indication is received a first time;
changing a configuration to communicate using the communications protocol determined; and
transmitting a second response when the indication is received a second time.

20. The method of claim 19, wherein receiving the signal occurs while emulating a smart card.

21. The method of claim 20, wherein changing the configuration comprises changing from a smart card emulation to a peer-to-peer communications protocol configuration.

22. The method of claim 18 further comprising:
receiving a signal from another device not including the indication; and
communicating with the other device according to a proximity card technique.

23. A computer program product comprising at least one computer-readable storage medium having computer-readable program code portions stored therein, the computer-readable program code portions comprising:
a first executable portion for receiving a signal from a device including an indication of a communication capability of the device;
a second executable portion for determining a communications protocol based on the indication; and
a third executable portion for communicating using the communications protocol determined.

24. The computer program product of claim 23 further comprising:
a fourth executable portion for transmitting a first response when the indication is received a first time;
a fifth executable portion for changing a configuration to communicate using the communications protocol determined; and
a sixth executable portion for transmitting a second response when the indication is received a second time.

25. The computer program product of claim 24, wherein the fifth executable portion is further configured for changing from a smart card emulation that is ongoing upon receipt of the signal to a peer-to-peer communications protocol configuration.

26. The computer program product of claim 23 further comprising:
a fourth executable portion for receiving a signal from another device not including the indication; and
a fifth executable portion for communicating with the other device according to a proximity card technique.

27. An apparatus comprising:
means for receiving signals including an indication of a communication capability of a device, wherein the communication capability comprises a communications protocol;
means for transmitting signals in response to the signals received; and
means for providing for the signals to be transmitted via the communications protocol based on the indication received.

28. A system comprising:
a first device configured to transmit a signal including an indication of a communication capability; and
a second device configured to receive the signal and to communicate with the first device;
wherein the second device is configured to provide a first response to the first device and to communicate with the first device using a communications protocol based on the indication if the second device has a communication capability that corresponds with the communication capability indicated by the first device.

29. The system of claim 28, wherein the second device is configured to provide a second response to the first device if the second device has a communication capability that does not correspond with the communication capability indicated by the first device, and wherein the first device is configured to communicate with the second device according to a proximity card technique.

30. The system of claim 28, wherein the first device is configured to communicate with the second device using a peer-to-peer communications protocol based on the second response.

31. The system of claim 28, wherein the first device comprises a point-of-sale device.

32. The system of claim 31 further comprising a clearance element configured to receive data from the first device over a wide area data network regarding payment by the second device.

33. The system of claim 32, wherein the clearance element is configured to communicate with the second device to update account information based on the data received from the first device.

34. The system of claim 28, wherein the first device is configured to repeat transmission of the signal including the indication to the second device if the response from the second device to a first transmittal of the indication comprises a second response.

35. The system of claim 28, wherein at least one of the first and second devices comprises a mobile terminal.
